(19) United States
(12) Patent Application Publication
(10) Pub. No.: US 2014/0294044 A1
(43) Pub. Date: Oct. 2, 2014

(54) TEMPERATURE AND HUMIDITY MEASURING APPARATUS AND METHOD

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: FU-MING LIU, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/136,046

(22) Filed: Dec. 20, 2013

(30) Foreign Application Priority Data
Mar. 29, 2013 (CN) 2013101099378

(51) Int. Cl. G01K 1/02

(52) U.S. Cl. CPC G01K 1/022
USPC 374/142

(57) ABSTRACT

An apparatus for measuring temperature and humidity includes a detecting unit, an A/D converting unit, a storage unit, a processing unit and a display unit. The detecting unit determines a temperature reading and a humidity reading, and outputs analog signals according to the temperature reading and the humidity reading. The A/D converting unit receives the analog signals, and converts the analog signals to digital signals. The storage unit stores multiple reference temperature values and multiple reference humidity values. The processing unit receives the digital signals, and compares the digital signals with the reference temperature values and the reference humidity values to determine whether the digital signals are valid. The processing unit converts the digital signals which are valid to temperature values and humidity values. The storage unit receives and stores the temperature values and the humidity values. The display unit receives and displays the temperature values and the humidity values.

### BACKGROUND

1. Technical Field

The present disclosure relates to an apparatus and method for measuring temperature and humidity.

2. Description of Related Art

A conventional method for measuring temperature and humidity of environment is by using a thermometer or a hygrometer. The temperature value and the humidity value are manually recorded by an operator. Recording of the temperature and the humidity values may be laborious and time consuming.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of an apparatus for measuring temperature and humidity.

FIG. 2 is a flowchart of an embodiment of a method for measuring temperature and humidity.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

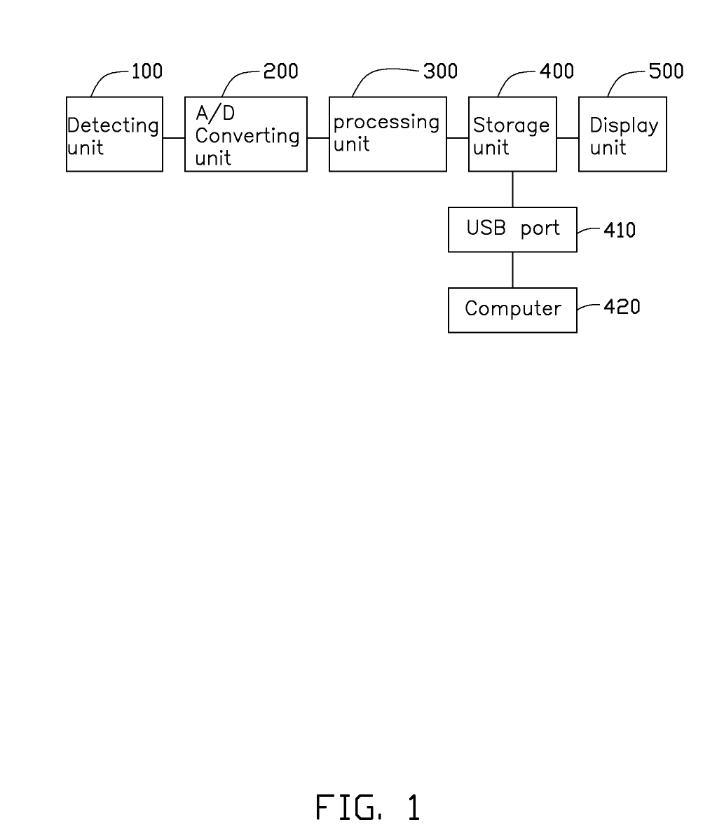

FIG. 1 shows an apparatus for measuring temperature and humidity in accordance with one embodiment. The apparatus includes a detecting unit 100, an analog to digital (A/D) converting unit 200, a processing unit 300, a storage unit 400 and a display unit 500. The storage unit 400 stores multiple reference temperature values and multiple humidity values.

The detecting unit 100 determines a temperature reading and a humidity reading, and outputs analog signals according to the temperature reading and the humidity reading. The A/D converting unit 200 receives the analog signals, and converts the analog signals to digital signals. The processing unit 300 receives the digital signals, and compares the digital signals with the reference temperature values and the reference humidity values to determine whether the digital signals are valid. The processing unit 300 determines the digital signals are valid when the digital signals are within a range of the reference temperature values and within a range of the reference humidity values. The processing unit 300 converts the digital signals which are valid to temperature values and humidity values. The storage unit 400 receives and stores the temperature values and the humidity values. The processing unit 300 generates a waveform of temperature and a waveform of humidity according to the temperature values and the humidity values. The waveform of temperature and the waveform of humidity are stored in the storage unit 400. The display unit 500 receives and displays the temperature values, the humidity values, the waveform of temperature and the waveform of humidity.

In one embodiment, the storage unit 400 includes a Universal Serial Bus (USB) port 410. The storage unit 400 is configured to communicate with a computer 420 via the USB port 410. The storage unit 400 is configured to transmit the temperature values, the humidity values, the waveform of temperature and the waveform of humidity to the computer 420 via the USB port 410.

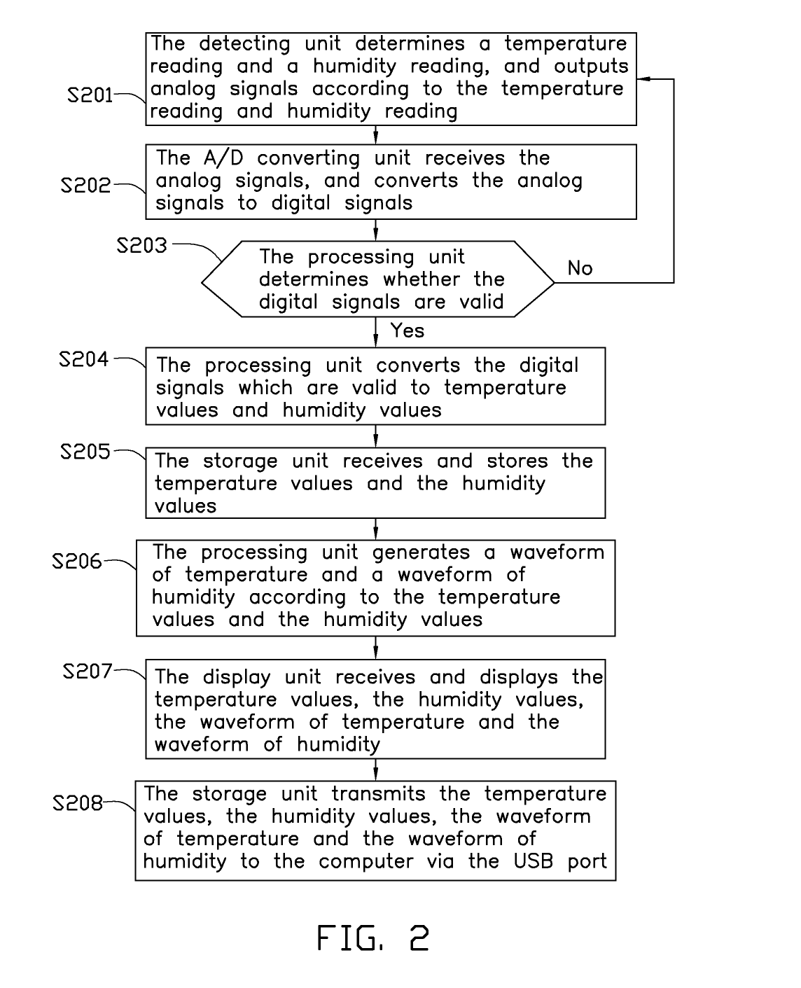

FIG. 2 shows a flowchart of a method for measuring temperature and humidity in accordance with one embodiment. Depending on the embodiment, certain steps described below may be removed, while others may be added, and the sequence of the steps may be altered. In one embodiment, the method for testing working voltage of a CPU utilizing the above-described system includes the following steps:

S201: the detecting unit 100 determines a temperature reading and a humidity reading, and outputs analog signals according to the temperature reading and humidity reading;

S202: the A/D converting unit 200 receives the analog signals, and converts the analog signals to digital signals;

S203: the processing unit 300 receives the digital signals, and compares the digital signals with the reference temperature values and the reference humidity values to determine whether the digital signals are valid; if the digital signals are not within the range of the reference temperature values and not within the range of the reference humidity values, returns to step S201; if the digital signals are within the range of the reference temperature values and within the range of the reference humidity values, the digital signals are valid, the procedure goes to step S204;

S204: the processing unit 300 converts the digital signals which are valid to temperature values and humidity values;

S205: the storage unit 400 receives and stores the temperature values and the humidity values;

S206: the processing unit 300 generates a waveform of temperature and a waveform of humidity according to the temperature values and the humidity values;

S207: the display unit 500 receives and displays the temperature values, the humidity values, the waveform of temperature and the waveform of humidity;

S208: the storage unit 400 transmits the temperature values, the humidity values, the waveform of temperature and the waveform of humidity to the computer 420 via the USB port 410.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A temperature and humidity measuring apparatus comprising:
a detecting unit configured to determine a temperature reading and a humidity reading, and output analog signals according to the temperature reading and the humidity reading;
an analog to digital (A/D) converting unit configured to receive the analog signals, and convert the analog signals to digital signals;
a storage unit configured to store a reference temperature range and a reference humidity range;
a processing unit configured to receive the digital signals, and compare the digital signals with the reference temperature values and the reference humidity values to determine whether the digital signals are valid; wherein the digital signals are valid when the digital signals are within a range of the reference temperature range and within a range of the reference humidity range; the processing unit converts the digital signals which are valid to temperature values and humidity values; the storage unit receives and stores the temperature values and the humidity values; and
a display unit configured to receive and display the temperature values and the humidity values.

2. The temperature and humidity measuring apparatus of claim 1, wherein the processing unit generates a waveform of temperature according to the temperature values and a waveform of humidity according to the humidity values; the waveform of temperature and the waveform of humidity are stored in the storage unit; and the display unit receives and displays the waveform of temperature and the waveform of humidity.

3. The temperature and humidity measuring apparatus of claim 2, wherein the storage unit comprises a Universal Serial Bus (USB) port; the storage unit is configured to communicate with a computer via the USB port; and the storage unit is configured to transmit the temperature values, the humidity values, the waveform of temperature and the waveform of humidity to the computer via the USB port.

4. A temperature and humidity measuring method comprises the following steps:
determining a temperature reading and a humidity reading and outputting an analog signal of the temperature reading and an analog signal of the humidity reading by a detecting unit;
receiving and converting the analog signal of the temperature reading and the humidity reading to digital signals of the temperature reading and the humidity reading, respectively, by an analog to digital (A/D) converting unit;
receiving and comparing the digital signals of the temperature reading and the humidity reading with a reference temperature range and a reference humidity range, respectively, to determine whether the digital signals are valid by a processing unit, wherein the digital signals are valid when the digital signals of the temperature reading and the humidity reading are within a range of the reference temperature range and a range of the reference humidity range, respectively ;
converting the digital signals of the temperature reading and the humidity reading which are valid to temperature values and humidity values, respectively, by the processing unit;
receiving and storing the temperature values and the humidity values by a storage unit;
receiving and displaying the temperature values and the humidity values by a display unit; and
transmitting the temperature values and the humidity values to a computer via a Universal Serial Bus (USB) port by the storage unit.

5. The temperature and humidity measuring method of claim 4, wherein if the digital signals of the temperature reading and the humidity reading are not within the range of the reference temperature range and the range of the reference humidity range, respectively, returns to the step of determining the temperature reading and the humidity reading.

6. The temperature and humidity measuring method of claim 5, further comprising generating a waveform of temperature and a waveform of humidity by the processing unit after receiving and storing the temperature values and the humidity values by the storage unit.

7. The temperature and humidity measuring method of claim 6, further comprising receiving and storing the waveform of temperature and the waveform of humidity together with the temperature values and the humidity values by the storage unit; and receiving and displaying the waveform of temperature and the waveform of humidity together with the temperature values and the humidity values by the display unit.

8. The temperature and humidity measuring of claim 4, further comprising transmitting the waveform of temperature and the waveform of humidity to the computer via the USB port together with the temperature values and the humidity values by the storage unit.
